(19) United States
(12) Patent Application Publication
(10) Pub. No.: US 2011/0202471 A1
(43) Pub. Date: Aug. 18, 2011

(54) METHOD AND SYSTEM FOR SELLING MOTOR VEHICLES

(75) Inventors: David Cyrus Scott, Orange, CA (US); Scott Vickers, Irvine, CA (US); Tami McBride, Costa Mesa, CA (US); Brian Wansolich, Newport Beach, CA (US)

(73) Assignee: KELLEY BLUE BOOK CO., INC., IRVINE, CA (US)

(21) Appl. No.: 13/023,326

(22) Filed: Feb. 8, 2011

Related U.S. Application Data
(60) Provisional application No. 61/304,192, filed on Feb. 12, 2010.

(51) Int. Cl. G06Q 10/00

(52) U.S. Cl. 705/306

(57) ABSTRACT

A method of providing an estimated value of a vehicle comprises providing access for a user to a server, wherein the user provides a data for a vehicle to the website. The data is stored in a user database and assigned an identification code. The server calculates an estimated vehicle value based on data provided by the user, wherein the estimated vehicle value is calculated at a first point in time. The estimated value of the vehicle is provided to the user. A vehicle advertisement is generated, wherein the identification code is embedded in the advertisement, wherein the advertisement provides the value of the vehicle calculated at the first point in time. The server receives the identification code at a second point in time, wherein the second point in time is after the first point in time, wherein the identification code is obtained from the embedded identification code. The data is retrieved from the user database using the identification code and the updated estimated vehicle value is calculated at substantially the second point in time. The updated estimated vehicle value is sent to a user system, wherein the server provides the updated estimated vehicle value sent to the user system.

### CROSS-REFERENCE TO RELATED APPLICATIONS

This application claims priority to U.S. application Ser. No. 61/304,192, filed Feb. 12, 2010, titled METHOD AND SYSTEM FOR SELLING MOTOR VEHICLES, the entire contents of which are incorporated by reference herein and made a part of this specification.

### BACKGROUND

A variety of methods are known for determining the value of a vehicle. There are services and websites dedicated to providing the values of vehicles based on information that a user provides to the website or the website provides to the user about the vehicle. For example, a user could provide the vehicle make and model, the model year of the vehicle, vehicle options, condition of the exterior and other details about the vehicle to the website. The website could use this information to estimate the value of the vehicle.

The services are generally consulted by sellers and buyers of used vehicles. A selling party will generally use the service to determine the value of the vehicle they are selling, and consequently their list price for the vehicle. Prospective purchasers of vehicles use value services to see if the selling price of a vehicle is comparable to the value of the vehicle as calculated by the valuation service.

Many times it is difficult for the potential purchaser to assess the value of the vehicle without viewing the vehicle and afterwards it is difficult for the purchaser to remember all of the details necessary for the valuation service to determine an accurate price of the vehicle. In some instances the selling party may provide a comparative value, calculated by a valuation service, alongside the vehicle list price. However, the comparative value of the vehicle may have been calculated months earlier and does not reflect an up to date value of the vehicle.

### BRIEF DESCRIPTION OF THE DRAWINGS

Throughout the drawings, reference numbers are re-used to indicate correspondence between referenced elements. The drawings are provided to illustrate embodiments of the inventions described herein and not to limit the scope thereof.

FIG. 1 illustrates an embodiment of a network environment for providing users with access to an electronic value system.

FIG. 2 illustrates an embodiment of a process for determining the value of a vehicle using an electronic value system.

FIG. 3 illustrates an embodiment of a process for determining a vehicle value using a phone.

FIG. 4 illustrates an embodiment of a process for determining a vehicle value using QR code.

FIG. 5 illustrates an embodiment of a process for determining a vehicle value using a dynamic advertisement.

FIG. 6 illustrates an embodiment of a user interface depicting an example of a toolkit service.

FIG. 7 illustrates an embodiment of a static advertisement generated using a toolkit service.

FIG. 8 illustrates an embodiment of a dynamic advertisement generated using a toolkit service.

FIG. 9 illustrates an embodiment of an internet-based application generated using a toolkit service.

FIG. 10 illustrates another embodiment of an internet based application generated using a toolkit service.

### DETAILED DESCRIPTION

### I. Introduction

A service that allows buyers and sellers of vehicles to assess the real-time value of vehicles at the point of inspection of the vehicle is beneficial to the buyer and seller. The service helps facilitate the transaction between the buyer and seller by providing the buyer with the appropriate market value of the vehicle and provides the seller with the tools to maintain a competitive price in the market. Further, the service can be used by a buyer to verify a seller's asserted market value.

For purposes of illustration, the processes disclosed herein are described primarily in the context of an electronic valuation system for the purpose of providing an estimated vehicle value. As will be apparent, however, the disclosed processes can also be used in other types of systems, and can be used to provide valuation services for other types of items, such as but not limited to real estate, boats, antiques, books, electronics, clothing, and any other item or service. In addition, the disclosed processes need not be implemented as part of, or in conjunction with, a web site. Further, although the systems and methods described herein provide valuation services for vehicles, more generally, the systems and methods can provide a valuation service for any product or service that consumers buy and sell.

As used herein, the terms “user,” “seller,” and “purchaser” are used interchangeably to refer to a user that is using a user system to access the electronic valuation system or utilize the system disclosed herein. Preferably, as will be apparent from the context, certain aspects of the system are suited for sellers, while others are suited for purchasers.

### II. Overview of Electronic Valuation System

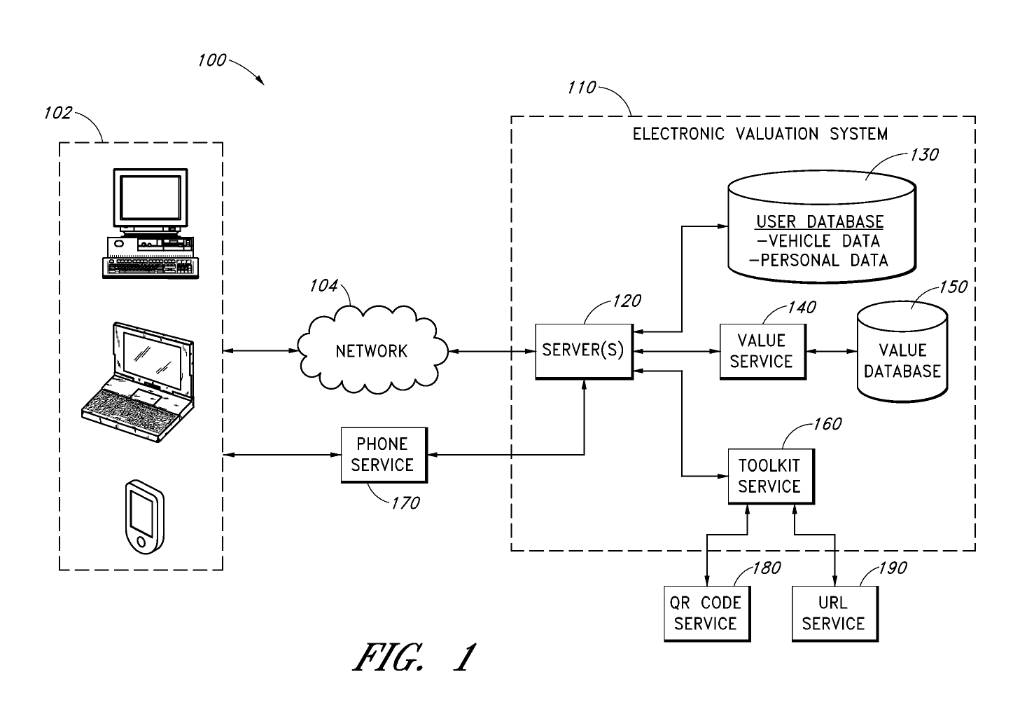

FIG. 1 depicts an embodiment of a network environment 100 suitable for providing users with access to an electronic valuation system 110. In the network environment 100, users can access the electronic valuation system 110 with user systems 102. The electronic valuation system 110 calculates an estimated value of goods and services. In a preferred embodiment the electronic valuation system 110 calculates an estimated value of a vehicle.

The user systems 102 that access the electronic valuation system 110 are computing devices, which can include desktop computers, laptop computers, tablets, personal digital assistants (PDAs), mobile phones, electronic book readers, other wireless handheld devices, set-top or other television boxes, media players, game consoles, or kiosks, among others. The user systems 102 access the electronic valuation system 110 over a network 104, which can be a local area network or a wide area network (including the Internet).

The electronic valuation system 110 can be implemented with one or more physical servers or computing machines. Thus, each of the components depicted in the electronic valuation system 110 can include hardware and/or software for performing various features. In one embodiment, the electronic valuation system 110 is a web site. In the depicted embodiment, the electronic valuation system 110 includes several components. For instance, the electronic valuation system 110 includes one or more servers 120 for receiving and responding to network requests from user systems 102. The one or more servers 120 can include web servers, application servers, database servers, combinations of the same, or the like. In a preferred embodiment a user accesses a website maintained on the server 120 to access the electronic valuation system 110. The electronic valuation system 110 also includes a value service 140 and a toolkit service 160 in communication with the one or more servers 120.

The electronic valuation system 110 can be used as a source of information for purchasers and sellers of vehicles. A user can access the electronic valuation system 110 to browse vehicles the user is looking to purchase and/or sell, and their respective values. Potential purchasers will generally use the electronic valuation system 110 as a reference point for the value of vehicles. Vehicle sellers will generally use the service to determine a list price for their vehicle. The electronic valuation system 110 content can include information about vehicles such as vehicle value, standard vehicle equipment, and vehicle availability. In one embodiment, the content can be arranged in a hierarchical structure, having vehicles associated in one or more categories or browse nodes in a hierarchy. The electronic valuation system 110 can provide functionality for users to browse the vehicle hierarchy in addition to searching for specific vehicles by vehicle year, make, and model. Users can select an item represented in the hierarchy or from a list of options to further refine their inquiry. The service will prompt the user to select or provide additional information until the system can identify the specific vehicle that the user is inquiring about. In response to the user's selections the server 120 can provide a data report page (or vehicle detail page) that includes details about the vehicle and an estimated vehicle value.

The value service 140 calculates an estimated vehicle value. The value service 140 generally uses the information provided by the user to calculate the value of the vehicle. In order for the value service to calculate a vehicle value, specific information about the vehicle is required. For example, in one embodiment the user needs to identify the vehicle year, make, model, mileage, vehicle equipment, and vehicle condition. In some embodiments the value service 140 may require different information in order to assess an estimated value. The information provided by the user is recorded by the server 120 and supplied to the value service 140. Preferably the electronic valuation system 110 requires the user to provide sufficient information for the value service 140 to calculate an estimated value.

The value service 140 is in communication with a value database 150. The value database 150 may comprise a plurality of individual databases. In some embodiments the value service and value database may reside on the same server and reside in the same database. The value database 150 may be maintained by an independent third party. Preferably the value database 150 contains the most recently updated information used to calculate the estimated value. Each database may contain value information related to specific parameters used to determine the estimated value. The value database 150 may include all of the value information in a single database. In a preferred embodiment the estimated vehicle value is calculated in part by the information contained in a value database 150 and in part by a value algorithm.

In one embodiment the value service 140 retrieves data from a plurality of value databases 150 and uses an algorithm to calculate the estimated vehicle value. For example, a base value database provides an estimated base vehicle value. The estimated base vehicle value may be adjusted based on the reported odometer mileage, which adjustments may be based upon information obtained from a mileage value adjustment database. The estimated base vehicle value may be adjusted based on the reported condition of the vehicle, which adjustments may be based upon information obtained from a condition value adjustments database. The estimated base vehicle value may be adjusted based upon the reported vehicle equipment, which adjustments may be based upon information obtained from a vehicle equipment value database. Based on the information collected the value service calculates the estimated vehicle value. After the value service 140 has determined an estimated vehicle value, the value is provided to the user in a data report.

The electronic valuation system 110 includes a user data repository or database 130. The user database 130 may be a separate server or a cloud-computing platform, such as Microsoft Azure or other appropriate hardware or system. The user database 130 stores information provided by the user to the electronic valuation system 110. The user database 130 may store all of the information provided by the user when the user is using the electronic valuation system 110. The data collected may include vehicle data and personal data. The vehicle data may include the vehicle year, make, model, mileage, vehicle equipment, vehicle identification number (VIN) and vehicle condition. The personal data may include information such as, the user name, telephone number, email address, IP address, or other information provided by or extracted from the user. Each grouping of data may be assigned a unique identification code or user identification code. The identification code allows the server to retrieve the data related to the user at a subsequent time. The server may retrieve all or part of the data. Further the server may modify, add, and/or delete data associated with the user identification code.

The electronic valuation system 110 also includes a toolkit service 160. The user has access to the toolkit service 160 through the electronic valuation system 110. The toolkit service 160 provides an interface for the user to create a plurality of static and dynamic advertisements, which may be used to promote and sell a vehicle. The advertisements provide means for a user to access an updated vehicle value. The updated value is calculated at a point in time after the initial vehicle value is calculated. Static advertisements may be generated, which provide methods for a user to access the updated vehicle value. Dynamic advertisements may be generated, which are preferably accessed through a network and provide the updated estimated vehicle value each time they are loaded or accessed.

The advertisements contain toolkit-generated information and user-generated information. The toolkit-generated information may include the estimated vehicle value, instructions for retrieving the updated vehicle value, and vehicle data, which is stored in the user database. The user-generated information may include portions or all of the personal data, which is stored in user database.

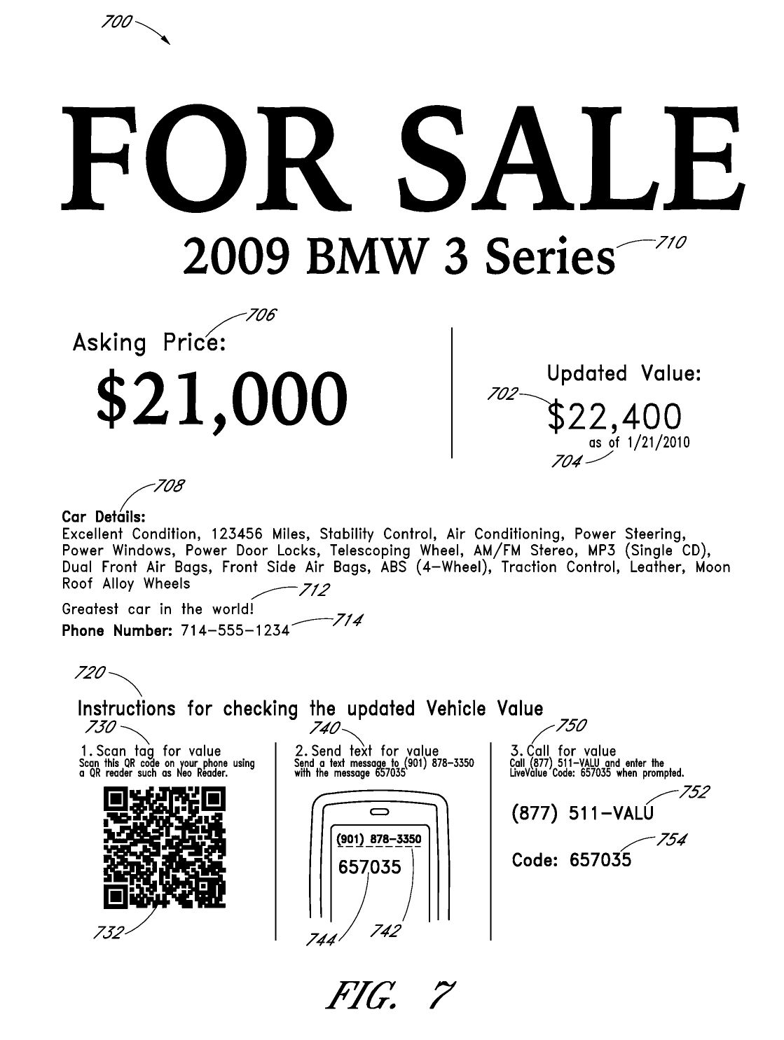

The toolkit service 160 can generate static advertisements including window stickers or other static on-vehicle advertisements, print media advertisements, and other non-internet advertisements. An embodiment of a static advertisement 700 is illustrated in FIG. 7. The static advertisement 700 provides toolkit-generated information and user-generated information. The user-generated information includes the vehicle asking price 706, user comments 712, and user contact information 714. The toolkit-generated information includes the advertisement layout, the vehicle year, make, and model 710, the estimated vehicle value 702, the date the estimated vehicle value was calculated 704, the vehicle details 708, which includes the vehicle mileage, and description of the equipment included with the vehicle. The toolkit also generates instructions informing a potential purchaser how to retrieve an updated estimated vehicle value for the vehicle 720. In this embodiment the advertisement includes instructions for accessing the updated vehicle value via a QR code 730, an SMS text messaging service 740, and a voice call service 750. In other embodiments the advertisement may include other types of instructions for accessing the updated vehicle value, such as a bar code or URL link.

In this embodiment the instructions for retrieving the updated vehicle value via QR code 730 include an image of a QR code 732. In some embodiments a bar code may be used. A QR code is a matrix barcode, or two-dimensional code, that consists of black modules arranged in a square pattern on white background, which contain encoded information such as text, a URL, or other data. QR codes and bar codes are readable by QR scanners or cell phones and mobile devices equipped with the appropriate software and hardware to scan the QR or bar code image. In some embodiments the QR code will contain a URL for a website. The QR code is generated by a QR code service 180, which may be a third party service. In this embodiment the QR code 732 contains a URL for a website. The potential purchaser may scan the QR code. The embedded URL directs the purchaser to a webpage that connects to the server 120. The webpage loads a dynamically generated data report that includes the updated estimated vehicle value. The webpage may be optimized for mobile devices.

In this embodiment the instructions for retrieving the updated vehicle value via an SMS text messaging service 740 include an SMS text address or phone number 742 and a SMS code 744. To retrieve the updated vehicle value the prospective purchaser can send a text message with the SMS code 744 by cell phone or other appropriate device to the phone number 742. A phone service 170 responds to the text message with a responsive text message. The text message includes the updated estimated vehicle value and additional information, such as a URL link to a more detailed data report.

In this embodiment, the instructions for retrieving the updated vehicle value via a voice call service 750 include a telephone number 752 and a phone code 754. To retrieve the updated vehicle value the prospective purchaser calls the telephone number 752. The telephone number 752 will connect the purchaser to a phone service 170 where the user will enter in the phone code 754. An audible voice will provide the updated estimated vehicle value and additional information to the purchaser.

In some embodiments the static advertisement may include an Internet URL. The URL may be a shortened URL provided by a URL service 190. The potential purchaser can enter the URL address into a network capable device. URL will direct the purchaser to a webpage that connects to the server 120. The webpage loads a dynamically generated data report that includes the updated estimated vehicle value. The data report may be formatted and generated for mobile devices.

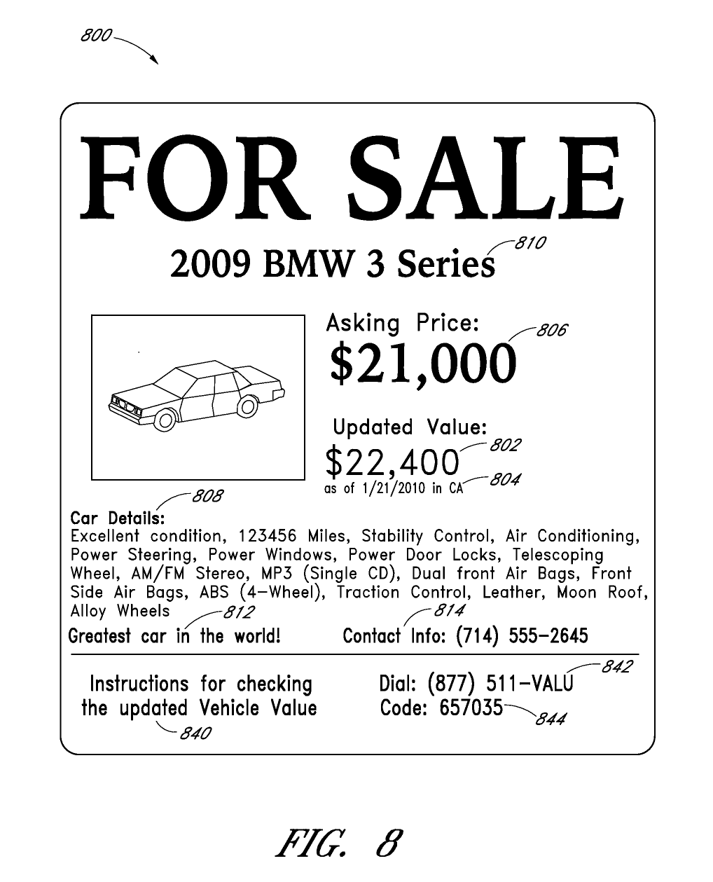

The toolkit service can generate dynamic advertisements including URLs, internet-based software applications, and dynamic images. The dynamic advertisements allow a vehicle seller to advertise a network or internet outlets such as online internet marketing, automotive reseller's websites, online classified ads, and social media pages. The dynamic advertisements provide toolkit-generated information and user-generated information. An embodiment of a dynamic advertisement is illustrated in FIG. 8. The user-generated information includes the vehicle asking price 806, comments 812, and contact information 814. The toolkit-generated information includes the advertisement layout, the vehicle year, make, and model 810, the estimated vehicle value 802, the vehicle details 808, which may include the vehicle condition, vehicle mileage, and description of vehicle equipment. Preferably dynamic advertisements update the estimated vehicle value every time the advertisement is accessed or loaded. The dynamic advertisements may include the date the estimated vehicle value was calculated.

In some embodiments the dynamic advertisement may be text or graphic hyper-links to an Internet web page that links the potential purchaser to a website that displays the dynamically generated and updated estimated vehicle value and related information. The URL may be a shortened URL that allows the seller to conveniently post the URL in text messages or on social media sites such as twitter and Facebook. A URL service 190, such as bitly, may provide the shortened URL.

In some embodiments the dynamic advertisement may be a software application that can be integrated into a social media website, such as Facebook, to display a data report containing a dynamically updated estimated vehicle value. The software application may also be an internet ad widget used to display at least a portion of the data report in online advertisements or social media websites. In some embodiments the dynamic advertisement may be a linked graphic, such as a digital image with an integrated software application to provide the data report to the user.

### III. Value Updating Process Embodiments

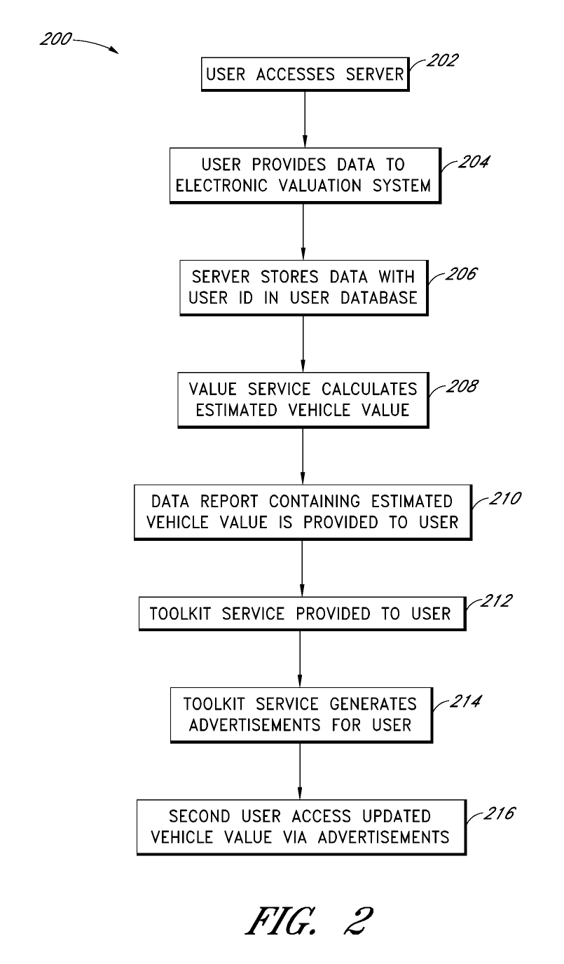

FIG. 2 illustrates the process for determining an estimated vehicle value 200. In block 202 a user with a user system 102 accesses the server 120 of the electronic valuation system 110 through a network 104. The server 120 provides the user with access to the electronic valuation system. In block 204 the user provides data to the electronic valuation system 110. The user data may include vehicle and personal data. The vehicle data may include the vehicle year, make, model, trim level, vehicle equipment, VIN, mileage, and vehicle condition. The personal information may include the user's name, contact information, e-mail address, phone number and address. In block 206 the server stores the user data with a user identification code in a user database 130. The data is retrievable using the user identification code. A portion or all of the stored data may be retrieved from the user database 130 as necessary.

In block 208 the value service 140 calculates an estimated value of the vehicle. The value service calculates the estimated value of the vehicle identified by the vehicle data provided by the user. The value service uses data obtained from a value database 150 and an algorithm to calculate an estimated vehicle value. In one embodiment the value database 150 calculates an estimated base vehicle value based upon the make, model, year, trim level, and standard equipment description of the vehicle. The estimated base vehicle value may be adjusted based on the reported odometer mileage, reported condition of the vehicle, and reported vehicle equipment. The value service compiles the data and calculates the estimated vehicle value. The estimated vehicle value and additional information is compiled into a data report.

In block 210 the estimated vehicle value is provided to the user in a data report. In some embodiments the data report may include additional value information related to the vehicle. For example, the data report may include the vehicle values for different reported conditions of the vehicle, such as excellent, good, fair, and poor. Additionally the data report may also include vehicle values dependent upon the potential purchaser, such as trade-in value, private party value, and suggested retail value.

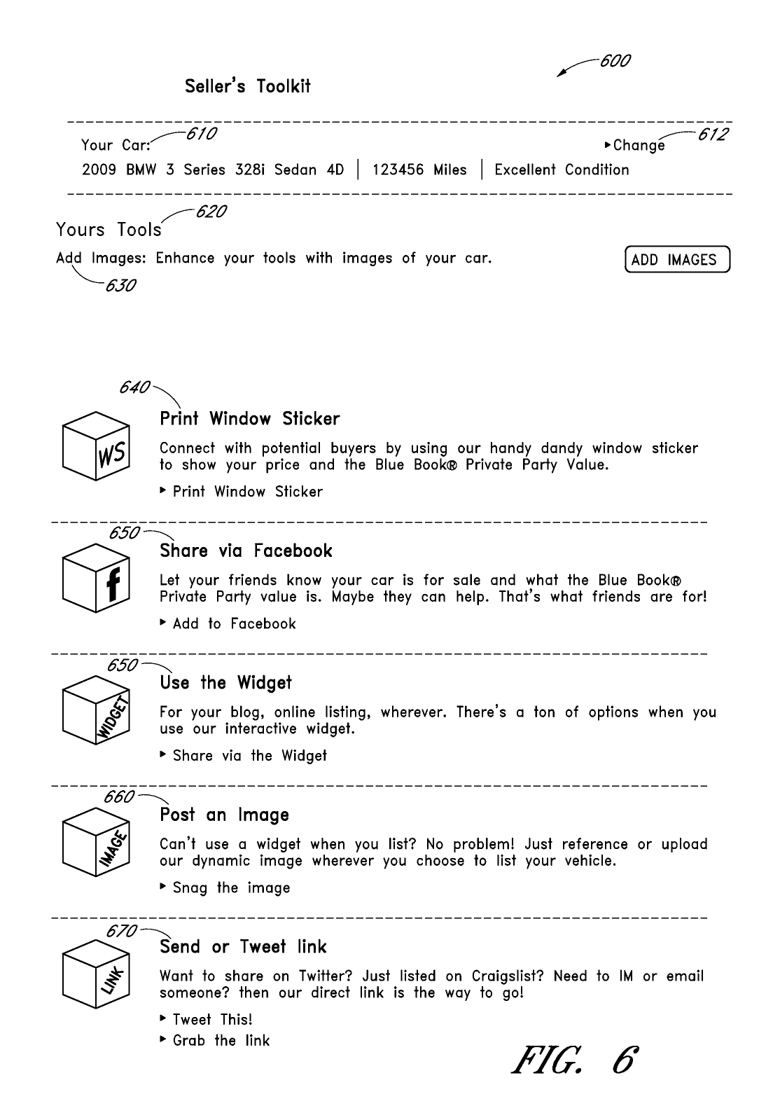

In block 212, a toolkit service is provided to the user. The user can use the toolkit service to generate advertisements. The advertisements allow a user to access an updated estimated vehicle value for the vehicle data corresponding to the user identification code. The toolkit service may provide the user a toolkit interface that allows the user to easily navigate and generate advertisements. One embodiment of a toolkit interface is illustrated in FIG. 6.

In block 214 the user uses the toolkit service to generate advertisements for the vehicle. The advertisements created by the toolkit service can be static or dynamic advertisements. The user advertises the vehicle using the static and/or dynamic advertisements.

In block 216, a potential purchaser or user accesses an updated estimated vehicle value, through either the static or dynamic advertisements. The dynamic advertisements provide an updated estimated value of the vehicle when the advertisement is accessed. Preferably, the dynamic advertisements are accessed on a user system through a network and the updated estimated value is provided to the potential purchaser or user without requiring the potential purchaser to take additional steps after the advertisement is accessed. Preferably the static advertisements have a date the estimated vehicle value was updated. The static advertisements provide instructions to the potential purchaser for accessing an updated estimated vehicle value, which may be via SMS messaging, voice call service, or QR code.

In some embodiments the advertisements also include additional information about the vehicle, including the seller's description of the make, model, year, trim level, and standard equipment description of the vehicle, the seller's reported odometer mileage, the seller's reported condition of the vehicle, and the seller's reported optional equipment on the vehicle. In some embodiments, the advertisements may only include a portion of the information.

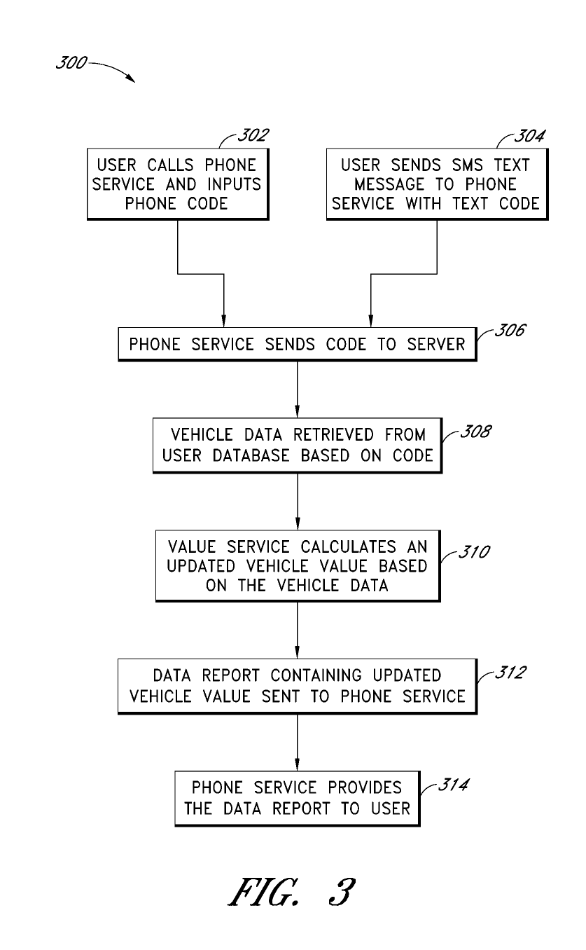

FIG. 3 illustrates an embodiment of the process for receiving an updated estimated vehicle value via a phone call or SMS text message 300. Preferably the potential purchaser has access to a static advertisement, which includes instructions generated by the toolkit service 160. FIG. 7 illustrates an embodiment of static advertisement 700. The static advertisement 700 includes instructions for accessing an updated estimated vehicle 720 value using an SMS text message 740 and using a voice dialing system 750.

In block 302 the potential purchaser calls the phone service 170 via the phone number provided 742 and inputs the phone code 754. Preferably, the potential purchaser receives a short welcome message and is prompted to provide the phone identification code 754 to the phone service 170.

In block 306 the phone service 170 sends the phone identification code 754 to the server 120. In some embodiments the phone identification code 744 is the same as the user identification code that is stored in the user database 130. In other embodiments the phone identification code 754 is a proxy identification code that references the user identification code, which the server 120 uses to retrieve the vehicle data from the user database 130. Preferably the phone identification code 754 provides the server 120 sufficient information to access the vehicle data in the user database 130. In some embodiment the phone service 170 is a third party service provider. The phone service 170 may translate the phone identification code into computer code and send it to the server 120.

In block 308 the vehicle data is retrieved from the user database 130 using the phone identification code 754. Preferably the server 120 has software or hardware implemented to receive and interpret the translated code from the phone service. The server 120 uses information contained in the code to retrieve the vehicle data from the user database 130.

In block 310 the value service 140 calculates an updated estimated vehicle value based on the vehicle data. The value service 140 receives the vehicle data identified by the code. In some embodiments the data may be in XML format. The value service calculates an updated estimated vehicle value based on the vehicle data at the time the request is received using the method previously described.

In block 312 the data report containing the updated estimated vehicle value is sent to the phone service. The server 120 converts the data report into the appropriate format and sends it to the phone service 170. The phone service 170 receives and processes the data report.

In block 314 the phone service converts the data report to the appropriate format and provides it to the user. In a preferred embodiment an automated voice communicates the updated estimated vehicle value to the user. In some embodiments the, phone service will also communicate additional information, such as vehicle year, make, model, and reported vehicle condition. Preferably there is only a short delay after the potential purchaser enters the phone identification code until the updated estimated vehicle value is returned.

FIG. 3 illustrates another embodiment beginning at block 304, where the potential purchaser sends an SMS text message to retrieve the updated vehicle value. In this embodiment the potential purchaser sends an SMS text message with the text identification code 744 to the number provided 742 in the advertisement 700. The SMS text message service 170 may be the same phone service used in conjunction with the phone call service. In some embodiments the phone call service and the text message service may be performed by different providers.

In block 306 the phone service 170 sends the text identification code 744 to the server 120. Preferably the server 120 is maintained with software and/or hardware to receive the code 744 from the phone service. In block 308 the server uses the text identification code 734 to retrieve the vehicle data from the user database 130. In block 310 the value system 140 uses the vehicle data to calculate an updated estimated vehicle value. In block 312 the server prepares a data report containing the data report, which includes the updated estimated vehicle value. The server sends the data to the phone service provider 170. In block 314 the phone service 170 prepares and sends an SMS text message containing the data report to the potential purchaser. In some embodiments the data report sent to the user includes the vehicle year, make, model, reported condition, reported odometer mileage, updated estimated vehicle value, and a URL directing the potential purchaser to a webpage with a more detailed data report for the vehicle.

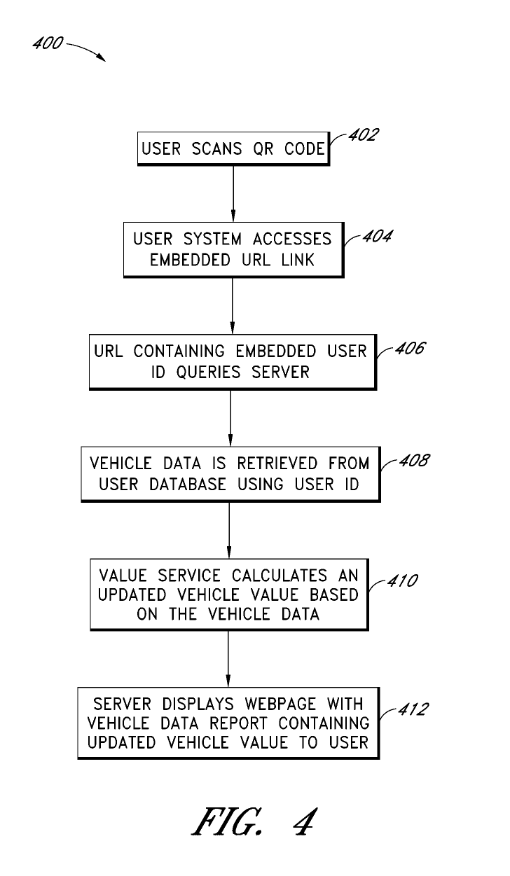

FIG. 4 illustrates an embodiment of a process for accessing an updated estimated vehicle value using a QR code 400. Some embodiments of static advertisements may have QR codes or bar codes displayed. An example of a static advertisement 700 with a QR code 732 is illustrated in FIG. 7. In order to access the updated estimated vehicle value, the potential purchaser needs a system 102 capable of reading a QR code and operating on a network 104 that can access the electronic valuation system 110, such as a smart phone with the appropriate software and hardware. The QR code may be printed on a window sticker type advertisement.

In block 402 the user scans the QR or bar code on the static advertisement. In block 404 the user system accesses the URL link embedded within the QR or bar code. Preferably the mobile device will automatically open a web browser after the QR code is scanned and attempt to access the embedded URL. The URL directs the potential purchaser to a data report for the vehicle, which contains an updated estimated vehicle value. The data report may be optimized for mobile devices.

In block 406 the URL embedded in the QR code queries the server. Embedded within the URL is a URL identification code, which provides the server 120 with sufficient information to determine the user identification code and retrieve the vehicle data from the user database 130. In some embodiments the URL identification code is the same as the user identification code stored in the user database 130. In other embodiments the URL identification code is a proxy identification code that references the user identification code, which the server uses to retrieve the vehicle information from the user database 130.

In block 408 the server 120 uses the URL identification code to retrieve the vehicle data from the user database 130. In block 410 the value service 140 calculates an updated estimated vehicle value based on the vehicle data using the method described previously. In block 412 the server 120 displays the appropriate webpage on the user's system. The webpage contains the vehicle data report, which includes the updated estimated vehicle value calculated at the time the server received the request from the user. The vehicle data report may include additional information such as, the vehicle year, make, model, reported condition, reported odometer mileage, and reported equipment of the vehicle.

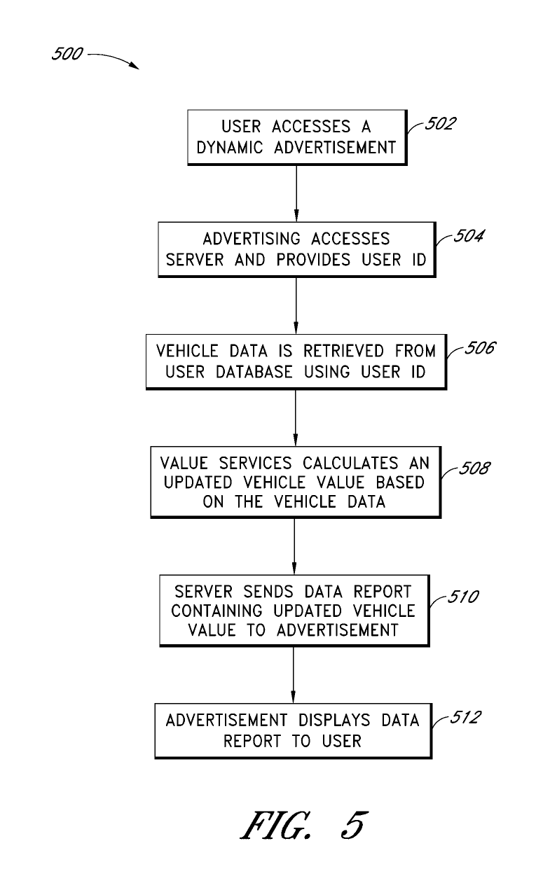

FIG. 5 illustrates an embodiment of a process for accessing an updated estimated vehicle value via a dynamic advertisement 500. Dynamic advertisements provide users access to a vehicle data report that is accessed through a network. The data report, or portions thereof, may be accessed by users in online Internet advertisements, including automotive reseller's websites, online classified ads, and social media pages.

In block 502 a user accesses a dynamic advertisement or application. The estimated vehicle value is updated when the application loads. In block 504 the application accesses the server 120 and provides the server 120 with sufficient information to determine the user identification code. In some embodiments the application may provide the user identification code to the server 120. In other embodiments the application may provide a proxy identification code to the server 120, which references the user identification code.

In block 506 the server 120 uses the user identification code to retrieve data from the user database 130. In block 508 the value system 140 calculates an updated vehicle value based on the vehicle data using the method previously described. In block 510 the server 120 sends a data report containing the updated estimated vehicle value and additional information to the application. In block 512 the application displays the data report to the user. The data report includes the updated vehicle value and may include additional vehicle data and personal data stored in the user database 130. The vehicle data may include additional vehicle year, make, model, reported condition, reported odometer mileage, and reported equipment of the vehicle. The user data may include vehicle asking price, seller contact information, and additional user comments. Embodiments of dynamic advertisements and applications are illustrated in FIGS. 7 through 10.

### IV. Toolkit Service Embodiments

FIG. 6 illustrates an embodiment of an interface for a toolkit service 600 offered as part of an electronic valuation system 110. In this embodiment the toolkit service interface 600 displays vehicle information 610 and a plurality of options for using the toolkit service 620. The toolkit service 600 further comprises a vehicle editing function 612, a static advertisement creator 640, a plurality of dynamic software applications 650, a dynamic advertisement creator 660, a plurality of options for creating a URL link 670, and an image uploading option 630. In another embodiment the toolkit service may provide an option to send the advertisement to an e-paper device.

The user the may edit or modify the vehicle information using the vehicle editing function 612. If the user edits or modifies the vehicle information, the vehicle value is recalculated to reflect the changes made by the user. The user may use the toolkit service to generate static and dynamic advertisements. For example the user may use a dynamic application to advertise the vehicle on a social networking site, such as Facebook. The user may also print a static advertisement to place on the vehicle itself.

In one embodiment the toolkit service 600 allows the user to set a dynamic asking price for the vehicle. The dynamic asking price for the vehicle will automatically adjust the asking price based on the updated vehicle value. The dynamic asking price may be set based on a percentage of value, a certain amount of money, or other option. For example a user may set the asking price at 98% of the vehicle value. The user could also set the asking price at $50 below the estimated value. Each time the service provides an updated vehicle value it will also provide an updated asking priced based on the specific user criteria. In other embodiments the user may set a trade-in value for the car or the service may provide other options for the user to price the vehicle.

In some embodiments, the advertisements generated by the toolkit may have additional features to verify the authenticity of the information provided in the advertisements and data reports. For example, a dynamic advertisement may have a url link that directs the user to a webpage that verifies the information provided in the advertisement. The SMS messaging and QR code embodiments could include similar systems. Further, the voice call service could provide the user with the date and time the updated vehicle value was calculated by the system. These features are useful to prevent changing or tampering with the toolkit generated information provided in the advertisements.

### V. Advertisement Embodiments

FIG. 7 is an embodiment of a static advertisement 700 generated by the toolkit service 160. The static advertisement 700 comprises a vehicle identifier 710, an asking price 706, an estimated vehicle value 702, a date the estimated vehicle value was calculated 704, additional details of the vehicle 708, additional comments supplied by the user 712, user contact information 714, and instructions for obtaining an updated vehicle value 720. In this embodiment there are instructions relating to a QR code 730, an SMS text message 740, and a voice call service 750.

In this embodiment, the advertisement displays toolkit generated information and user generated information. The toolkit generated information is generally used to calculate estimated value of the vehicle. This information includes the vehicle identification 710, the date 704, the vehicle details 708, the estimated vehicle value 702, and instructions related to retrieving an updated vehicle value. The user generated information includes the asking price 706, comments 712, and contact information 714. The user generated information may be modified by the user at any time. The user cannot modify the toolkit generated information without modifying the vehicle information in the toolkit interface 630. Changes to the vehicle information result in a recalculation of the vehicle value 702.

The QR code value option 730 comprises instructions and a QR code 732. As detailed above the QR code has information embedded within it that allows the user to access an updated vehicle value. The image of the QR code 732 displayed on the advertisement may be generated by the electronic valuation system 110 or it may be generated by a third party service provider 180. The user must scan the QR code to access the updated vehicle value, preferably with a smart phone or other capable device.

The SMS text value option 740 comprises instructions that include a text identification code 744 and a phone number 742. The code 744 provides information that allows the electronic valuation system 110 to provide the updated vehicle value. The phone number connects the user to a phone service 170, which may be the electronic valuation system 110 or it may be a third party service provider that functions as a relay or intermediary of the information between the electronic valuation system 110 and the user. After sending the message, the user receives an SMS message from phone service 170 with the updated value.

The phone call option provides a number 752 and a phone identification code 754. The potential purchaser calls the number which connects the user to a phone service 170 that will prompt the user for the code 754. The phone service 170 may be the electronic valuation system 110 or it may be a third party service provider, which functions to relay the information between the server and the user. The code 754 provides information that allows the electronic valuation system to provide the updated vehicle value. After the user provides the code 754, the phone service audibly provides a data report to the user, including an updated estimated vehicle value.

FIG. 8 is an embodiment of a dynamic advertisement 800 generated by the toolkit service 160. The dynamic advertisement 800 comprises a vehicle identifier 810, an asking price 806, an estimated vehicle value 802, a date the estimated vehicle value was calculated 804, additional details of the vehicle 808, user comments 812, contact information 814, and instructions for obtaining an updated vehicle value 810. In this embodiment the instructions are for a voice call service and comprise a telephone number 842 and a telephone identification code 844.

The dynamic advertisement 800 is an internet-based advertisement that is linked to the server via an internal URL. The image has an embedded identification code. When the image is loaded by a user, the image sends the identification code to the server and the electronic valuation system 110 uses the identification code to calculate the updated vehicle value 802 using the method described above.

Below the estimated vehicle value 802 is the date that the vehicle value was updated 804. Preferably the date will be up-to-date to the day that the user loads the image, showing that the vehicle value has been calculated using the most recent information from the database. In some instances the dynamic link to the server may be removed by a user and the advertisement 800 will not update the vehicle value 802 when the image is loaded. If the advertisement 800 does not dynamically update the vehicle value 802, the user may also receive an updated value by calling the telephone number 842 and providing the telephone identification code 844.

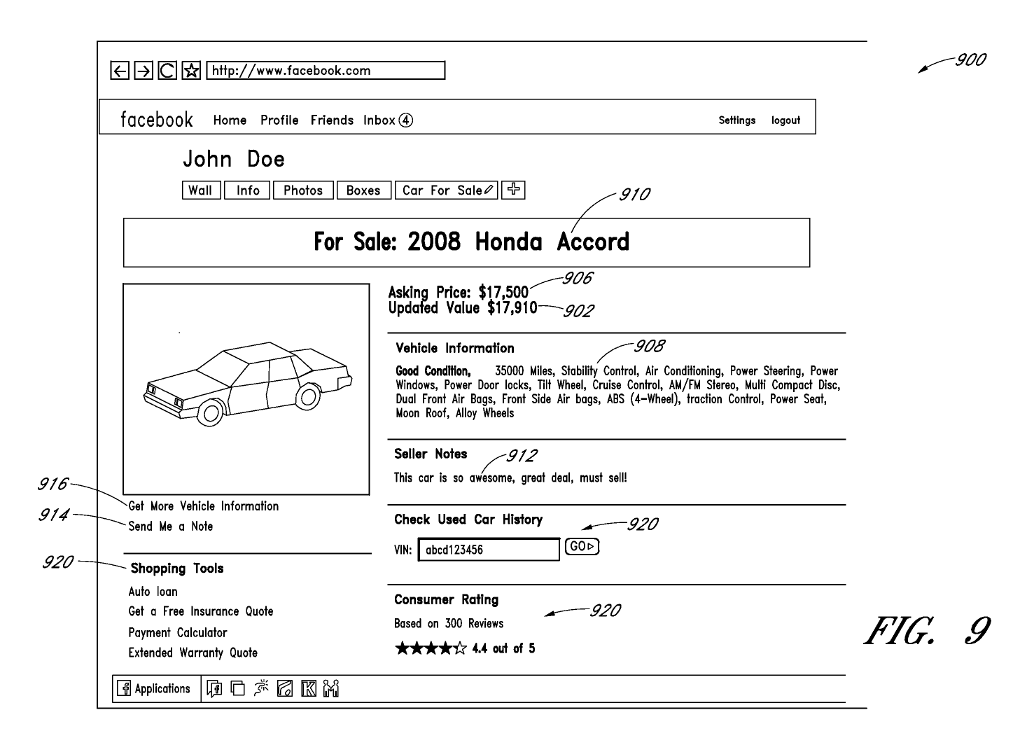

FIG. 9 is an embodiment of a dynamic application 900 generated by the toolkit service 160. The dynamic application 900 comprises a vehicle identifier 910, an asking price 906, an estimated vehicle value 902, additional details of the vehicle 908, additional comments supplied by the user 912, user contact information 914, and a link to additional vehicle information 916.

This embodiment of a dynamic application may be used on a social networking site, such as Facebook. The application 900 updates all of the provided information each time it loads. The application has an embedded identification code that it provides to the electronic valuation system 110. The electronic valuation system 110 provides all of the necessary information to the application and calculates the updated vehicle value 902 each time the application loads. In this embodiment the user can contact the seller of the vehicle by way of the link 914, which utilizes the communication tools provided by the social networking site. The user can also receive more detailed information about the vehicle through the link 916. Link 916 directs the user to a detailed data report provided on the website maintained by the electronic valuation system 110. In some embodiments the application may utilize additional features of a social networking site to provide additional information and/or features to the user 920.

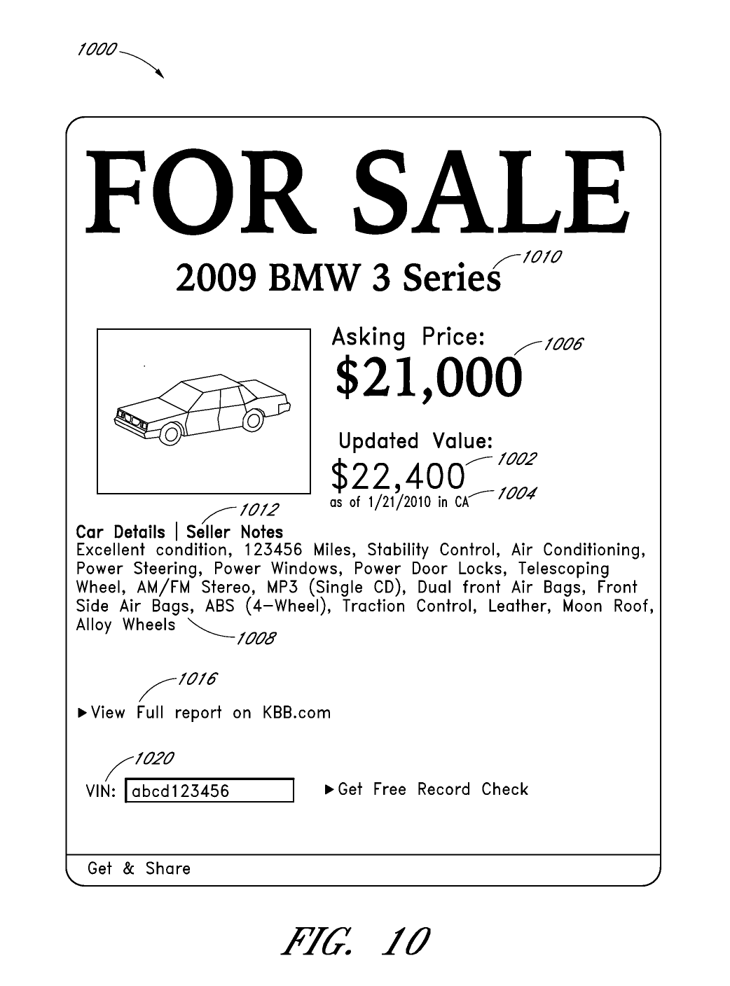

FIG. 10 is another embodiment of a dynamic application 1000 generated by the toolkit service 160. The dynamic application 1000 comprises a vehicle identifier 1010, an asking price 1006, an estimated vehicle value 1002, a date the estimated vehicle value was calculated 1004, additional details of the vehicle 1008, a tab for additional comments supplied by the user 1012, and a link to additional vehicle information 1016. In some embodiments the application may have additional features in order to provide additional information and/or features to the user 1020.

### VI. Terminology

Depending on the embodiment, certain acts, events, or functions of any of the algorithms described herein can be performed in a different sequence, can be added, merged, or left out all together (e.g., not all described acts or events are necessary for the practice of the algorithm). Moreover, in certain embodiments, acts or events can be performed concurrently, e.g., through multi-threaded processing, interrupt processing, or multiple processors or processor cores or on other parallel architectures, rather than sequentially.

The various illustrative logical blocks, modules, and algorithm steps described in connection with the embodiments disclosed herein can be implemented as electronic hardware, computer software, or combinations of both. To clearly illustrate this interchangeability of hardware and software, various illustrative components, blocks, modules, and steps have been described above generally in terms of their functionality. Whether such functionality is implemented as hardware or software depends upon the particular application and design constraints imposed on the overall system. The described functionality can be implemented in varying ways for each particular application, but such implementation decisions should not be interpreted as causing a departure from the scope of the disclosure.

The various illustrative logical blocks and modules described in connection with the embodiments disclosed herein can be implemented or performed by a machine, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor can be a microprocessor, but in the alternative, the processor can be a controller, microcontroller, or state machine, combinations of the same, or the like. A processor can also be implemented as a combination of computing devices, e.g., a combination of a DSP and a microprocessor, a plurality of microprocessors, one or more microprocessors in conjunction with a DSP core, or any other such configuration.

The steps of a method, process, or algorithm described in connection with the embodiments disclosed herein can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of computer-readable storage medium known in the art. An exemplary storage medium can be coupled to the processor such that the processor can read information from, and write information to, the storage medium. In the alternative, the storage medium can be integral to the processor. The processor and the storage medium can reside in an ASIC. The ASIC can reside in a user terminal. In the alternative, the processor and the storage medium can reside as discrete components in a user terminal.

Conditional language used herein, such as, among others, “can,” “might,” “may,” “e.g.,” and the like, unless specifically stated otherwise, or otherwise understood within the context as used, is generally intended to convey that certain embodiments include, while other embodiments do not include, certain features, elements and/or states. Thus, such conditional language is not generally intended to imply that features, elements and/or states are in any way required for one or more embodiments or that one or more embodiments necessarily include logic for deciding, with or without author input or prompting, whether these features, elements and/or states are included or are to be performed in any particular embodiment.

While the above detailed description has shown, described, and pointed out novel features as applied to various embodiments, it will be understood that various omissions, substitutions, and changes in the form and details of the devices or algorithms illustrated can be made without departing from the spirit of the disclosure. As will be recognized, certain embodiments of the inventions described herein can be embodied within a form that does not provide all of the features and benefits set forth herein, as some features can be used or practiced separately from others. The scope of certain inventions disclosed herein is indicated by the appended claims rather than by the foregoing description. All changes which come within the meaning and range of equivalency of the claims are to be embraced within their scope.

What is claimed is:

1. A method of providing an estimated value of a vehicle comprising:
providing access for a user to a server, wherein the user provides a data for a vehicle to the website;
storing the data in a user database;
assigning the data an identification code;
calculating an estimated vehicle value, wherein server calculates the estimated vehicle value based on data provided by the user, wherein the estimated vehicle value is calculated at a first point in time;
providing the estimated value of the vehicle to the user;
generating a vehicle advertisement, wherein the identification code is embedded in the advertisement, wherein the advertisement provides the value of the vehicle calculated at the first point in time;
receiving the identification code at a second point in time, wherein the second point in time is after the first point in time, wherein the server receives the identification code, wherein the identification code is obtained from the embedded identification code;
retrieving the data from the user database using the identification code;
calculating the updated estimated vehicle value at substantially the second point in time; and
sending the updated estimated vehicle value to a user system, wherein the server provides the updated estimated vehicle value sent to the user system.

2. The method of claim 1 wherein the embedded identification code is scanned by a mobile device, wherein the mobile device provides the identification code to the server.

3. The method of claim 1 wherein the embedded identification code is sent to a phone service in a text message, wherein the phone service provides the identification code to the server.

4. The method of claim 1 wherein the embedded identification code is sent to a phone service in a telephone call, wherein the phone service provides the identification code to the server.

5. The method of claim 1 wherein the embedded identification code is sent to the server by a dynamic advertisement.

6. The method of claim 1 wherein the embedded identification code is sent to the server by a dynamic application.

7. The method of claim 1 wherein the user system is a wireless handheld device.

8. The method of claim 1 wherein the user system is a personal computer.

9. The method of claim 1 wherein the user is a first user and the user system is operated by a second user.

10. A method of providing an updated value of a vehicle to a prospective buyer comprising:
receiving vehicle data, wherein a server receives the vehicle data;
assigning the vehicle data an identification code;
calculating an estimated vehicle value based upon the vehicle data, wherein an electronic valuation system calculates the value at a first point in time;
generating an advertisement containing the estimated vehicle value and the identification code;
receiving the identification code at a second point in time, wherein the identification code is provided by the prospective buyer, wherein the server receives the identification code;
calculating the updated vehicle value, wherein the updated vehicle value is calculated at substantially the second point in time; and
providing the updated vehicle value to the prospective buyer.

11. The method of claim 10 wherein the identification code is provided to the server via a wireless handheld device.

12. The method of claim 10 wherein the user system is a personal computer.

13. A method of assessing an estimated value of an item being sold comprising:
providing access for a user to a server, wherein the user provides information relating to the item for sale;
storing information provided by the user in a user database, wherein the information comprises personal data and item data;
assigning the information a user identification code;
retrieving value information from an item database, wherein the value information is retrieved based upon the item data provided by the user;
calculating the estimated item value, wherein the item value is calculated by a value service, wherein the value service uses the item data and the value information to calculate the item value, wherein the estimated item value is calculated at a first point in time;
providing the estimated item value to the user;
providing the user access to a toolkit service, wherein the toolkit service is capable of generating at least one advertisement customized to the information provided by the user;
generating at least one advertisement for the user, wherein the advertisement contains the estimated item value and the item identification code;
receiving the item identification code at a second point in time, wherein the item identification code is received by the server from a user system;
retrieving the item data from the user database using the identification code;
retrieving updated value information from the value database based upon the item data;
calculating an updated estimated item value using the item data and the updated value information at substantially the second point in time;
providing the updated estimated item value to the user system.

14. The method of claim 13 wherein an application accessed by the user system sends the identification code to the server.

15. The method of claim 13 wherein a URL accessed by the user system queries the server, wherein the identification code is embedded in the URL.
